(19) United States
(12) Patent Application Publication
(10) Pub. No.: US 2015/0206159 A1
(43) Pub. Date: Jul. 23, 2015

(54) GEOGRAPHIC MNEMONICS BASED MESSAGING

(71) Applicant: TollShare, Inc., Danville, CA (US)

(72) Inventors: Murali M. Karamchedu, Portland, OR (US); Ravi Asnani, Los Angeles, CA (US); Sanjay Nambiar, Los Angeles, CA (US)

(73) Assignee: TollShare, Inc., Danville, CA (US)

(21) Appl. No.: 14/161,580

(22) Filed: Jan. 22, 2014

(51) Int. Cl. G06Q 30/02; H04L 29/08; G06F 17/30

(52) U.S. Cl. CPC G06Q 30/0205; G06F 17/30241; H04L 67/22; G06Q 30/0269

(57) ABSTRACT

Apparatuses, methods and storage medium associated with geographic mnemonics based messaging are disclosed herein. In embodiments, an apparatus may include a data collection module configured to collect demographics of users interacting with a geographic mnemonics associated with a location or an area that includes the location. In response to a request from a requestor for the demographics of users interacting with the geographic mnemonics, the data collection module may respond to the requestor with collected demographics of users interacting with the geographic mnemonics, to enable the requestor to select and transmit a message to the client device, based at least in part on the collected demographics of users interacting with the geographic mnemonics. Other embodiments may be described and/or claimed.

### RELATED APPLICATION

The subject matter of the present application is related to U.S. patent application Ser. No. ______, attorney docket 125621-190213, entitled “Geographic Mnemonics,” contemporaneously filed.

### TECHNICAL FIELD

The present disclosure relates to the field of data processing, in particular, to apparatuses, methods and storage medium associated with geographic mnemonics based messaging services.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Advances in computing, networking and related technologies have led to proliferation in the availability of multi-media contents, and their consumption through public networks, such as the Internet. Ever since the advance of the Internet and the World Wide Web, advertisers have been focused on targeting online advertisements. For examples, Internet portals have put much effort into targeting the banner advertisements (Ads), based on the content of the web pages being browsed; search engines have put much effort into targeting advertisements based on keywords; and social networks have put their effort into targeting advertisements based on social graphs. Most recently, Internet portals, search engines, social networks, and so forth, have put their effort into targeting advertisements based on current locations of mobile client devices. For example, Internet portals et al have targeted advertisements of businesses in the general neighborhood, based on current locations of mobile devices. As another example, search engines, travel sites et al have targeted advertisements of hotels, restaurants et al, based on searches for things to do, or points of interest at a location.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an arrangement for providing geographic mnemonics based messaging service, in accordance with various embodiments.

FIG. 2 illustrates an example organization of the geographic mnemonics and their associated data, in accordance with various embodiments.

FIG. 3 illustrates an example process for providing geographic mnemonics services, in accordance with various embodiments.

FIG. 4 illustrates an example process for providing geographic mnemonics based demographic services, in accordance with various embodiments.

FIG. 5 illustrates an example process for using geographic mnemonics service and/or geographic mnemonics based demographics service by other online services, in accordance with various embodiments.

FIG. 6 illustrates an example organization of the geographic mnemonics and the associated data, in accordance with various embodiments.

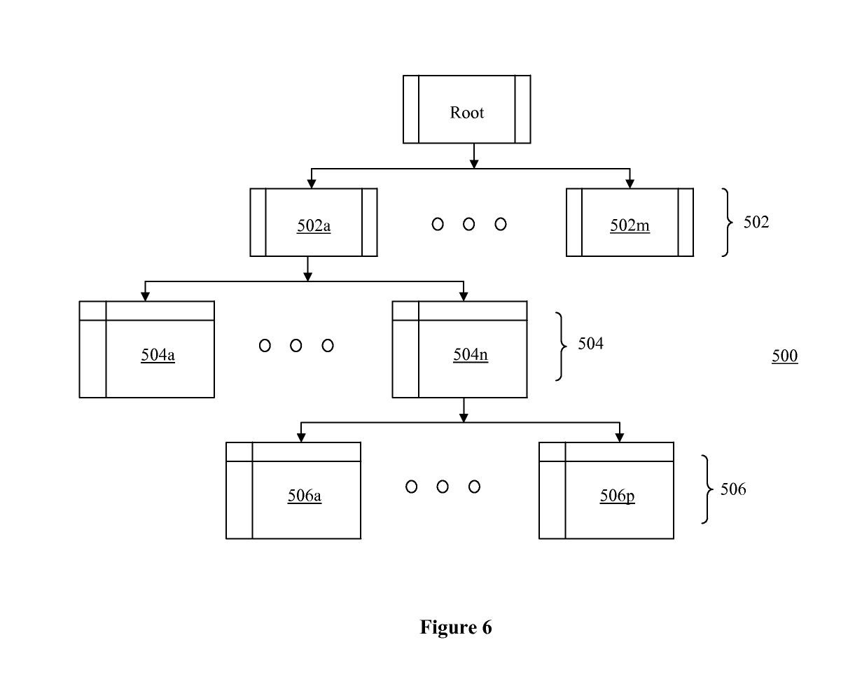

FIG. 7 illustrates an example computing environment suitable for practicing the disclosure, in accordance with various embodiments.

FIG. 8 illustrates an example storage medium with instructions configured to enable an apparatus to practice the processes of the present disclosure, in accordance with various embodiments.

### DETAILED DESCRIPTION

Apparatuses, methods and storage medium associated with geographic mnemonics based messaging are disclosed herein. In embodiments, an apparatus may include a data collection module configured to collect demographics of users interacting with a geographic mnemonics, e.g., “&ravi_home,” associated with a location or an area that includes the location. In response to a request from a requestor for the demographics of users interacting with the geographic mnemonics, the data collection module may respond to the requestor with collected demographics of users interacting with the geographic mnemonics, to enable the requestor to select and transmit a message to the client device, based at least in part on the collected demographics of users interacting with the geographic mnemonics.

Examples of sources for the demographics data may include, but are not limited to an Internet portal, an ecommerce site, a search engine, a social networking site, an email service, or a messaging service. Similarly, examples of a requestor for the demographics data may include, but are not limited to an Internet portal, an ecommerce site, a search engine, a social networking site, an email service, or a messaging service. An example of the message may be a commercial message.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous. The terms “commercial,” and “advertisement” as used herein are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

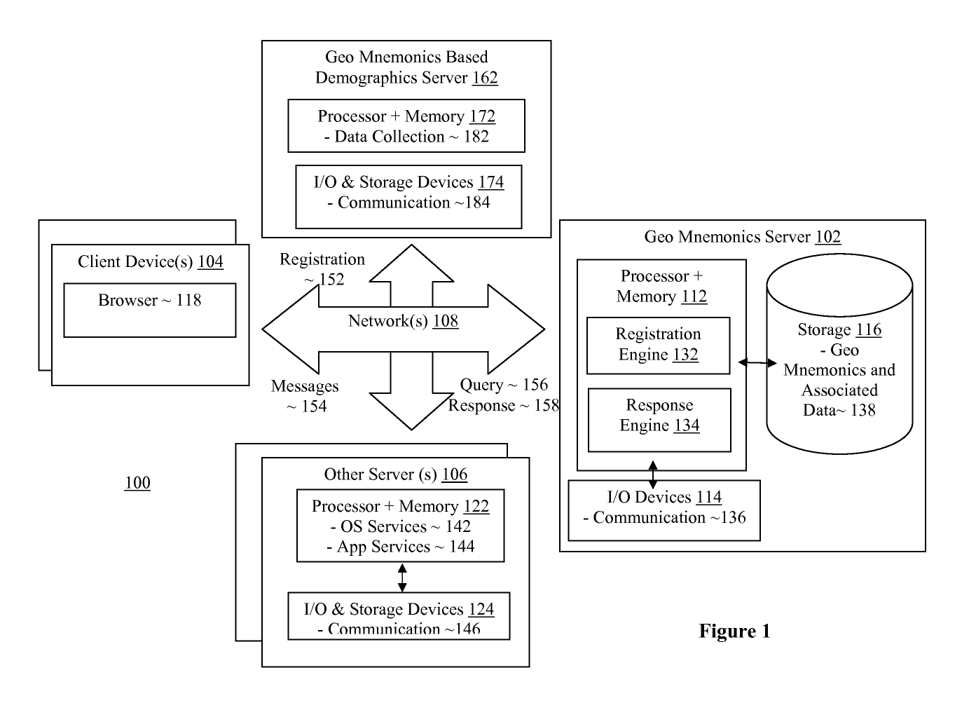

Referring now FIG. 1, wherein an arrangement for providing geographic mnemonics based messaging services, in accordance with various embodiments, is illustrated. As shown, in embodiments, arrangement 100 may include server 102 and server 162 respectively configured to offer geographic mnemonics registration and query services, and geographic mnemonics based demographic services for client devices 104 and/or servers 106 of other online services. Geographic mnemonics servers 102 and 162, client devices 104, and servers 106 of other online services may be coupled to one another via network 108, as shown. In embodiments, server 102 may include processor and memory arrangement 112, input/output device 114, and storage 116, coupled with each other as shown. Processor and memory arrangement 112 may be configured to host registration engine 132, and response engine 134. In embodiments, registration engine 132 may be configured to accept registration of geographic mnemonics and their associated addresses from client devices 102, and store the registered geographic mnemonics and their associated addresses in storage 116 for subsequent provision to client devices 104 and/or servers 106 of other online services, in facilitating providing information associated with a location or an area. In embodiments, registration engine 132 may be further configured to accept meta data associated with the geographic mnemonics, from client devices 102, and store the associated meta data of the geographic mnemonics in storage 116 for subsequent provision to client devices 104 and/or servers 106 of other online services. In embodiments, meta data may include demographics data of the owners of the geographic mnemonics. Response engine 134 may be configured to provide the appropriate registered geographic mnemonics, associated addresses and/or met data, in response to subsequent query from client devices 104, and/or servers 106 of other online services. In embodiments, response engine 134 may be configured to provide demographics data of the owners of the geographic mnemonics. In embodiments, server 102 may be configured to require users of client devices 104 who query about geographic mnemonics be registered or authorized by owners of the registered geographic mnemonics. For these embodiments, registration engine 132 may be further configured to likewise collect demographics data of the registered or authorized users of client devices 104 who query server 102 about geographic mnemonics.

In embodiments, the format of a geographic mnemonic may be defined by the geographic mnemonic service. In embodiments, the geographic mnemonic service may define a geographic mnemonic to have the format of one or more special characters, followed by any number of alphanumeric and special characters. For example, the geographic mnemonic service may define a geographic mnemonic to have the format of having the special character “&” as the lead off character, followed by one or more alphanumeric and special characters, such as “&Ravi_home,” or “&Schwabe_Seattle.” As another example, the geographic mnemonic service may define a geographic mnemonic to have the format of having the special characters “#&” as the lead off characters, followed by one or more alphanumeric and special characters, such as “#&Ravi_home,” or “&Schwabe_Seattle.” These examples are just illustrative, and not meant to be limiting on the present disclosure.

In embodiments, in the course of storing geographic mnemonics, their associated addresses and meta data 138 into storage 116, registration engine 112 may further resolve the geographic mnemonics, based on its associated address, to a pair of geographic coordinates or geographic coordinate ranges, e.g., a pair of geodetic latitude and longitude coordinates, or a pair of geodetic latitude and longitude ranges. For example, the City and County of San Francisco may register the geographic mnemonics “&Coit_Tower,” to facilitate provision of various information associated with the landmark Coit Tower under the present disclosure. The associated address of “&Coit_Tower,” is “1 Telegraph Hill, Blvd, San Francisco, Calif.” In the course of storing “&Coit_Tower” as the registered geographic mnemonics, “1 Telegraph Hill, Blvd, San Francisco, Calif.” as the associated address, and so forth, registration engine 112 may resolve the address of “1 Telegraph Hill, Blvd, San Francisco, Calif.” of “&Coit_Tower” to the geodetic latitude and longitude coordinate pair of {37.8025° N, 122.4058° W}, and store also the geographic coordinates. As another example, the law firm Schwabe, Williamson & Wyatt may register the geographic mnemonics “&SWW_Seattle,” to facilitate provision of various information associated with the Seattle Office. The associated address of “&SWW_Seattle,” is “1420 5^{th} Ave., Suite 3400, Seattle, Wash.” In the course of storing “&SWW_Seattle” as the registered geographic mnemonics, “1420 5^{th} Ave., Suite 3400, Seattle, Wash.” as the associated address, and so forth, registration engine 112 may resolve the address of “1420 5^{th} Ave., Suite 3400, Seattle, Wash.” of “&SWW_Seattle” to a pair of geodetic latitude and longitude coordinate, and store also the geographic coordinates. Further, in embodiments, registration engine 112 may organize the storage of the geographic mnemonics, their associated addresses, and meta data, based at least in part on the geographic coordinates to facilitate subsequent processing and retrieval.

While the above example illustrated the resolution to geodetic coordinates that are valued in accordance with a mathematical defined reference ellipsoid that approximates the Earth, the present disclosure is not so limited. Other geographic coordinates with other geographic reference systems may also be used, including but are not limited to, e.g., geocentric coordinates that are valued in accordance with a X-Y-Z reference centered at Earth's center, or spherical coordinates that are valued based on the radial distances from Earth's center, along with polar angles measured from the zenith directions of the positions, and azimuth angles of the positions based on orthogonal projections on corresponding reference planes that pass through Earth's center and orthogonal to the zenith directions.

While for ease of understanding, registration engine 132 and response engine 134 are being illustrated as being operated by processors of processor and memory arrangement 112, in embodiments, registration engine 132 and response engine 134 may be implemented in any combination of hardware and/or software. In embodiments, the combination of hardware and/or software may include processor(s), memory and executable instructions implementing the functions described herein. In embodiments, in lieu of being two separate engines, registration engine 132 and response engine 134 may share some common functions and/or resources. For example, registration engine 132 and response engine 134 may share common communication functions and components for communicating with client devices 104 and servers 106 of other online services. As a further example, registration engine 132 and response engine 134 may share processor and/or memory resources. In embodiments, some functions of registration engine 132 and response engine 134, or vice versa, may be combined.

Processor and memory arrangement 112, in addition to registration engine 132 and response engine 134, may further host execution of various operating system (OS) services (not shown). The OS services may include any one of a number of OS services known in the art, including but not limited to memory management, task management, and so forth. I/O devices 114 may include one or more communication interfaces 128 configured to facilitate communication with client devices 104, and servers 106 of other online services. Communication interfaces 128 may be any one of a number of communication components/interfaces known in the art, including but not limited to wired or wireless communication components for personal, local and/or wide area network communications. Storage 116 may be implemented using any magnetic, optical, and/or solid state non-volatile storage. The magnetic, optical, and/or solid state non-volatile storage may be disposed on one platform, or coupled/networked. In embodiments, storage 116 may also include volatile and/or non-volatile caches. Accordingly, except for the teachings of the present disclosure incorporated therein, server 102 is intended to represent a broad of single or multi-processor servers known in the art. In embodiments, server 102 may include one or more clusters computing servers, which may be coupled with one another, via one or more local or wide area networks (not shown).

Still referring to FIG. 1, client device 104 may include browser 118 configured to access the geographic mnemonics service offered by server 102, including interactions with registration engine 132 to register one or more geographic mnemonics, including their associated addresses and meta data, and/or interactions with response engine 134 to query and retrieve geographic mnemonics and/or associated data. Thus, client device 104, except for its usage and consumption of the geographic mnemonics service, represents a broad range of client devices known in the art, including but not limited to personal digital assistants (PDA), smartphones, computing tablets, ultrabook, laptop computers, desktop computers, set-top box, media players, game consoles, in-vehicle/portable navigation/infotainment systems, and so forth.

Similar to server 102, each of servers 106 may include processor and memory arrangement 122, and I/O and storage devices 124 coupled to with each other as shown. Processor and memory arrangement 122 may host OS Services 142 and application services 144, while I/O and storage devices 124 may include one or more communication interfaces 146. Similar to processor and memory arrangement 112, processor and memory arrangement 122 may be any one of a wide range of such elements known in the art. Likewise, similar to I/O devices 114 and communication interfaces 136, I/O and storage devices 124 and communication interfaces 146 may be any one of a wide range of such elements known in the art. As described earlier, OS Services 142 may include a wide range of OS services, including but not limited to memory management, task management, and so forth. In embodiments, application services 144 may be configured to use geographic mnemonics services offered by server 102, as well as collaborate and/or use geographic mnemonics based demographic services offered by server 162. Except for their usage of geographic mnemonics services offered by server 102, and/or their collaboration with, and/or usage of geographic mnemonics based demographic services offered by server 162, application services 144 may likewise be any one of a number of online services known it art. Examples of application services 144 may include, but are not limited to, Internet portal service, e-commerce service, online search services, social networking services, email and/or short messaging services, to be described in more detail below. In embodiments, application services 144, such as Internet portal service or e-commerce service, may also be configured to collect demographics data of their registered users, including whether they are owners of registered geographic mnemonics.

Continue to FIG. 1, geographic mnemonic based demographics server 162 may include processor and memory arrangement 172, and input/output and storage devices 174, coupled with each other as shown. Processor and memory arrangement 172 may be configured to host data collection module 182. In embodiments, data collection module 182 may be configured to collect demographics of users that interact with the various geographic mnemonics. Further, data collection module 182 may be configured to respond to a request from a requestor for the demographics of users interacting with the geographic mnemonics, with the collected demographics of users interacting with the geographic mnemonics. The requestor, or other applications affiliated with the requestor, in turn, may select and transmit a message to a client device, based at least in part on the collected demographics of users interacting with the geographic mnemonics. Resultantly, the requestor, or other applications affiliated with the requestor, may target messages to client devices 104, on a location basis, that are not just limited to current locations or interests in locations of client devices 104, but more broadly on the demographics of users interacting with geographic mnemonics that are associated with locations or areas that include the locations.

In embodiments, data collection module 182 may be configured to collect demographics data of users who interact with geographic mnemonics from a variety of sources. In embodiments, data collection module 182 may be configured to collect, from geographic mnemonics server 102, demographics of owners who register the geographic mnemonics with the geographic mnemonics service. In embodiments, data collection module 182 may be configured to collect, from an Internet portal or an ecommerce site server 106, demographics of their registered users, who are also owners of registered geographic mnemonics with the geographic mnemonics service. In embodiments, data collection module 182 may be configured to collect, from geographic mnemonics server 102, demographics of users who queried geographic mnemonics service server 102 about particular geographic mnemonics.

In embodiments, data collection module 182 may be configured to collect, from a search engine, demographics of users who issued searches to the search engine that triggered the search engine to query geographic mnemonics server 102 about the geographic mnemonics. In embodiments, data collection module 182 may be configured to collect, from a social networking site, demographics of users who associated themselves with the geographic mnemonics on the social networking site. In embodiments, data collection module 182 may be configured to collect, from an email service, demographics of users who send or receive emails that include the geographic mnemonics. In embodiments, data collection module 182 may be configured to collect, from a short messaging service server 106, demographics of users who follow the geographic mnemonics on the short messaging service. Accordingly, geographic mnemonics based demographics server 162 may be in possession of demographics data of a wide range of users who interact with geographic mnemonics.

Networks 108 may be any combinations of private and/or public, wired and/or wireless, local and/or wide area networks. Private networks may include, e.g., but are not limited to, enterprise networks. Public networks, may include, e.g., but is not limited to the Internet. Wired networks, may include, e.g., but are not limited to, Ethernet networks. Wireless networks, may include, e.g., but are not limited to, Wi-Fi, or 3G/4G networks. It would be appreciated that at the servers' end, networks 108 may include one or more local area networks with gateways and firewalls, through which servers 102, 106 and 162 go through to communicate with client devices 104 and each other. Similarly, at the client device end, networks 108 may include base stations and/or access points, through which client devices 104 communicate with servers 102, 106 and/or 162. In between the various ends may be any number of network routers, switches and other networking equipment of the like. However, for ease of understanding, these gateways, firewalls, routers, switches, base stations, access points and the like are not shown.

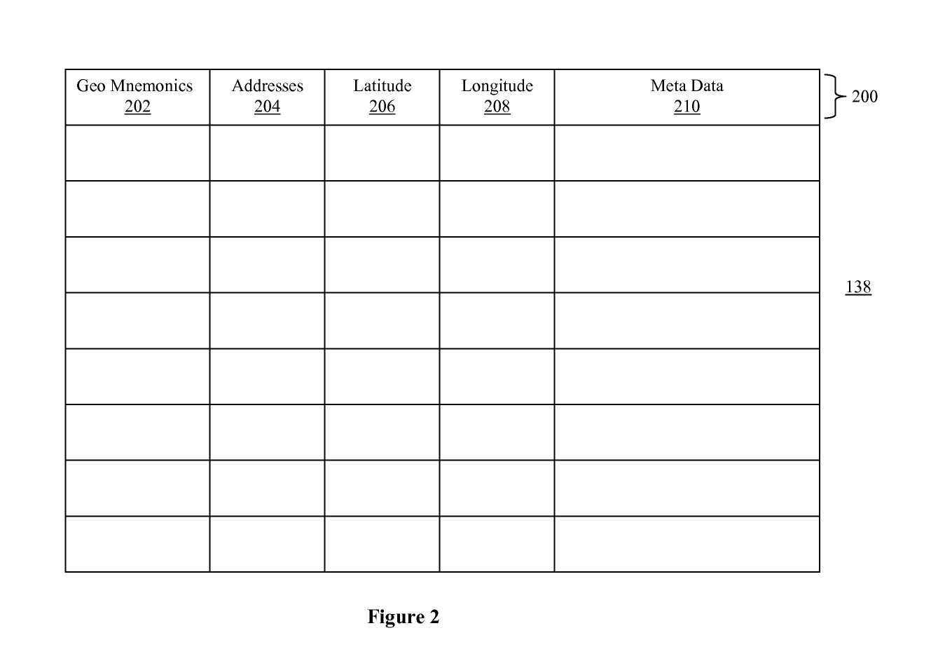

Referring now to FIG. 2, wherein an example organization of geographic mnemonics and their associated data, in accordance with various embodiments, is shown. As illustrated, in embodiments, each geographic mnemonics record 200 may include the registered geographic mnemonics 202, its associated address 204, and meta data 210. Further, for embodiments where registration engine 132 resolves the address to a set of geographic coordinates of a location on Earth's surface, e.g., a pair of latitude and longitude coordinates, record 200 may further include the geographic coordinates 206 and 208.

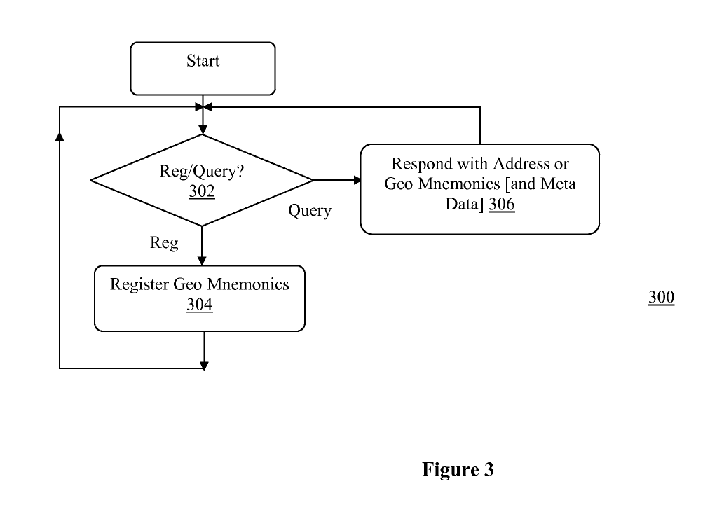

Referring now to FIG. 3, wherein an example process for providing geographic mnemonics services, in accordance with various embodiments, is illustrated. As shown, process 300 may include operations at blocks 302-306. The operations may be performed, e.g., by the earlier described registration engine 132 and response engine 134 of geographic mnemonics server 102.

At block 302, a request for service may be received. In response, a determination may be made on whether the request is for registration of a geographic mnemonics, for retrieving data associated to a geographic mnemonics or for retrieving geographic mnemonics at a location or within an area. An example request to register a geographic mnemonics may be a request to register, e.g., “&Coit_Tower” as geographic mnemonics. An example request for data associated to a geographic mnemonics may comprise a query for the address and/or meta data associated with a geographic mnemonics. An example request for geographic mnemonics may comprise a query for geographic mnemonics at an address, e.g., “1 Telegraph Hill, Blvd, San Francisco, Calif.”,” or information associated with a geographic mnemonics, or geographic mnemonics within an area, .e.g., “North Beach of San Francisco.” Note that one or more geographic mnemonics, e.g., geographic mnemonics registered by different family members of a family, such as “&AdamSmith_Home,” and “AnnaSmith_Home,” may resolve to the same address.

On determining that the request is for registration of a geographic mnemonics, process 300 may proceed to block 304. At block 304, the geographic mnemonics being registered may be accepted and stored, e.g., in storage 116. In embodiments, registration engine 132 may be configured to ensure each registered geographic mnemonics is unique, and deny registrations for geographic mnemonics that have already been registered. Additionally, acceptance and storage of the geographic mnemonics may include acceptance and storage of an address to be associated with the geographic mnemonics. For example, on accepting and storing the example geographic mnemonics of “&Coit_Tower,” the example address “1 Telegraph Hill, Blvd, San Francisco, Calif.,” may be accepted and stored as the address to be associated with the example geographic mnemonics of “&Coit_Tower.” The example geographic mnemonics is merely intended to be illustrative and is not to be read as limiting on the present disclosure. It is anticipated that a wide range of geographic mnemonics, including e.g., private geographic mnemonics, such as “&Ravi_home,” may be accepted and stored.

Further, in embodiments, concurrent with the initial registration or subsequent to the initial registration, acceptance and storage of the geographic mnemonics may further include acceptance and storage of meta data to be associated with the geographic mnemonics. For example, for the example geographic mnemonics of “&Coit_Tower,” meta data comprising a direction to Coit Tower, seasonal operating hours and so forth, may be accepted and stored. As another example, meta data may further comprise demographics data of the owners of the registered geographic mnemonics and/or users who are authorized to query about the geographic mnemonics. The example meta data are merely intended to be illustrative and are not to be read as limiting on the present disclosure. It is anticipated that a wide range of meta data may be accepted and stored for each geographic mnemonics. Thereafter, process 300 may return to block 302, and continue therefrom as earlier described.

Back at block 302, if the result of the determination is a request for data associated with a geographic mnemonics, geographic mnemonics at a location or within an area, or demographics data of the owners of the geographic mnemonics and/or users who query about the geographic mnemonics, process 300 may proceed to block 306. At block 306, in response to a request for data associated to geographic mnemonics, the response may include the associated address. Additionally, if the request also requested for meta data or particular type of meta, the response may further include some or all the meta data matching the request criteria. Still further, if the request is for demographics data of the owners of the geographic mnemonics or users who query about the geographic mnemonics, the response may include the requested demographics data of owners of the geographic mnemonics or users who query about the geographic mnemonics. Still further, for queries so indicated, the response may include information associated with other geographic mnemonics within an area associated with a geographic mnemonics. For example, in response to a query about the geographic mnemonics of San Francisco, if requested, the response may include information about geographic mnemonics associated with Coit Tower, Lombard Street, and so forth. Thereafter, process 300 may return to block 302, and continue therefrom as earlier described.

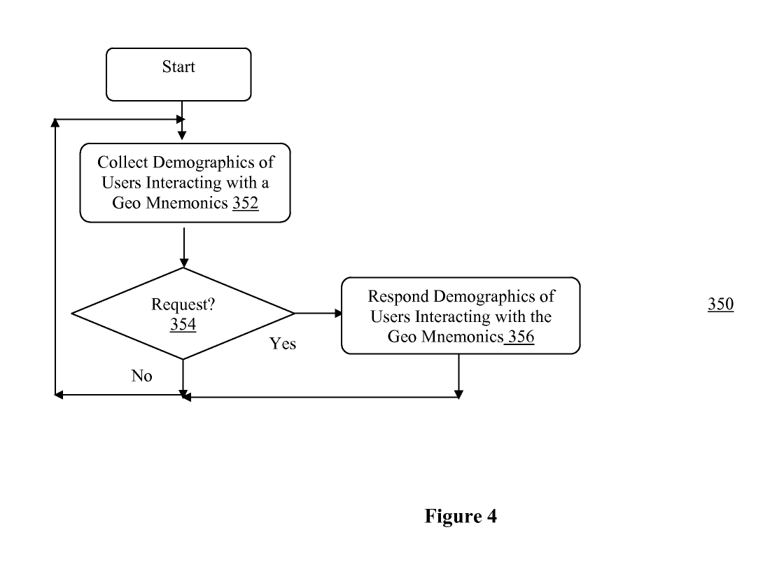

Referring now to FIG. 4, wherein an example process for providing geographic mnemonics based demographic services, in accordance with various embodiments, is illustrated. As shown, process 350 may include operations at blocks 352-356. The operations may be performed, e.g., by the earlier described data collection module 182 of geographic mnemonics based demographics server 182.

Process 350 may start at block 352. At block 352, demographics data of various users who interact with geographic mnemonics may be collected from a wide range of sources, as earlier described. From block 352, process 350 may proceed to block 354. At block 354, a determination may be made with respect to whether a request for the demographics data has been received. If a result of the determination indicates that a request for the demographics data of users who interact with a geographic mnemonics has been received from a requestor, process 350 may proceed to block 356. At block 356, the requested demographics data of users who interact with a geographic mnemonics may be provided to the requestor. As described earlier, the requestor may any one of client device 104 or server 106, offering any one of a wide range of online services. Further, for request so indicated, the response may include demographics data of users who interact with other geographic mnemonics within an area associated with a geographic mnemonics. For example, in response to a request for demographics data of users who interact with the geographic mnemonics of San Francisco, if requested, the response may include demographics data of users who interact with geographic mnemonics associated with Coit Tower, Lombard Street, and so forth. From block 356, process 350 may return the block 352, and proceed therefrom as earlier described. Similarly, if a result of the determination at block 354 indicates that no request for the demographics data of users who interact with a geographic mnemonics has been received, process 350 may likewise return to block 352, and proceed therefrom as earlier described.

Referring to FIG. 1 again, as described earlier, it is anticipated, in addition to client device 104, servers 106 of various online services may also utilize the geographic mnemonics services of geographic mnemonics server 102 or the geographic mnemonics based demographics services of geographic mnemonics server 162 to enhance the services they provide. For example, an online search service may support search for geographic mnemonics and/or information related to geographic mnemonics, thereby enhancing the user experience for searching for information related to a location or an area. On receipt of a search query, the search engine may determine whether the search query includes a geographic mnemonics, a request for information about a geographic mnemonics, or a request for geographic mnemonics at a location or within an area. On determination that the search query include a geographic mnemonics, a request for information about a geographic mnemonics, or a request for geographic mnemonics at a location or within an area, instead of treating these search criteria as keywords, the search engine may query geographic mnemonics server 102 for the information instead. Additionally, the online search service may obtain demographics data of users who interact with a geographic mnemonics from geographic mnemonics based demographics server 162, and target messages, such as commercial messages, the online search service selects and transmits to client devices 104.

In another non-limiting example, the online service may be a social networking service configured to facilitate client devices 102 to socially network with each other. In embodiments, the social networking service may extend its support to include supports that allow geographic mnemonics as “users.” As a result, owner user of geographic mnemonics may post contents against the geographic mnemonics. Other users may elect to be associated with the geographic mnemonics (“friend” the geographic mnemonics). These users may then see the posted contents for the geographic mnemonics, and/or receive notification from the social networking service about new contents being posted for the geographic mnemonics. Additionally, the social networking service may obtain demographics data of users who interact with a geographic mnemonics from geographic mnemonics based demographics server 162, and target messages, such as commercial messages, the social networking service selects and transmits to client devices 104.

In still another non-limiting example, the online service may be a messaging service configured to facilitate client devices 102 to message each other, including e.g., but not limited to, short messages. In embodiments, the messaging service may extend its support to include supports for geographic mnemonics. In other words, the messaging service may recognize a term starting off with the special characters “#&,” and followed by any number alphanumeric or special characters, as a geographic mnemonics, differ from other tagged words. As a result, a geographic mnemonics may become a tagged keyword or topic, enabling messages related the geographic mnemonics to be easily recovered. Additionally, the messaging service may obtain demographics data of users who interact with a geographic mnemonics from geographic mnemonics based demographics server 162, and target messages, such as commercial messages, the messaging service selects and transmits to client devices 104.

In still another non-limiting examples, the online service may be an Internet portal service, an e-commerce service or an email/messaging service configured to respectively facilitate client devices 104 to online content, online transactions, or electronic mail/messaging service. Similar to the earlier described example online services, the Internet portal service, e-commerce service or email/messaging service may obtain demographics data of users who interact with a geographic mnemonics from geographic mnemonics based demographics server 162, and target messages, such as commercial/advertisement messages, the Internet portal service, e-commerce service or email/messaging service selects and transmits to client devices 104.

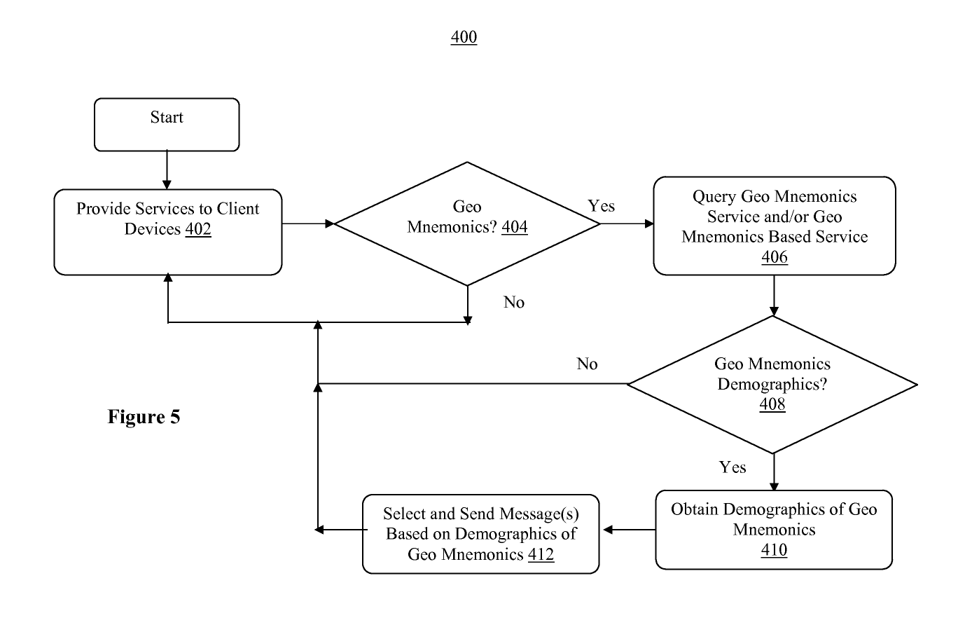

Referring now FIG. 5, wherein an example process for online services to utilize the geographic mnemonics service, in accordance with various embodiments, is illustrated. As shown, process 400 may include operations at blocks 402-412. The operations may be performed e.g., by application services 144 of FIG. 1 of various online services. As shown, process 400 may start at block 402. At block 402, an online service may provide its online services (such as, search, social networking, messaging, and so forth) to its users. From block 402, process 400 may proceed to block 404. At block 404, a determination may be made on whether a service requested involves geographic mnemonics, and whether assistance from geographic mnemonics server 102 is needed. On determination that the service requested involves geographic mnemonics, and assistance from geographic mnemonics server 102 is needed, process 400 may proceed to block 406. At block 406, the online service may query geographic mnemonics server 102 for address and/or meta data of a geographic mnemonics, or for geographic mnemonics at a location or within an area.

From block 406, process 400 may proceed to block 408. At block 408, a determination may be made with respect to whether to obtain demographics data of users who interact with the geographic mnemonics. On determination to obtain demographics data of user who interact with the geographic mnemonics, process 400 may proceed to block 410. At block 410, geographic mnemonics based demographics server 162 may be contacted to obtain the demographics data of users who interact with the geographic mnemonics. As described earlier, in embodiments, the demographics information, in addition to users who interact with a geographic mnemonics, may further include users who interact with other geographic mnemonics within an area of the geographic mnemonics.

From block 410, process 400 may proceed to block 412. At block 412, selection and transmission of messages, such as commercial/advertisement messages, to client devices 104 may be targeted, based at least in part on demographics data of users who interact with the geographic mnemonics and/or demographics data of users who interact with other geographic mnemonics associated with the geographic mnemonics.

From block 412, process 400 may return to block 402, and continue there from as earlier described. Similarly, at block 408, on determination not to obtain demographics data of user who interact with the geographic mnemonics, or at block 404, on determination that the service requested does not involve geographic mnemonics or not need the assistance of geographic mnemonics server 102, process 400 may return to block 402, and continue there from as earlier described. While for ease of understanding, the operations of determining whether to obtain demographics data of user who interact with the geographic mnemonics, and the operations of obtaining demographics data were described as part of the operations associated with determining whether to use the geographic mnemonics service of server 102, in embodiments, the two groups of operations may be separately and independently practiced by the online service.

Referring now briefly back to FIG. 2, in embodiments, the geographic mnemonics and their associated data 138 may be stored in storage 120 in any one of a number of data organizations or structures, to facilitate efficient traversal for identification of potential relevant geographic mnemonics and their associated data 138. FIG. 5 illustrates an example organization of the geographic mnemonics and their associated data 138, in accordance with various embodiments. Example organization 500 may be a hierarchical organization/structure having a number of organization levels, including one or more intermediate or node levels 502-504 and the lowest or leaf level 506. In embodiments, geographic mnemonics and their associated data having geographic coordinates of various specific locations may be stored in the lowest or leaf level 506, such as 506a . . . 506p. Further, geographic mnemonics and their associated data having geographic coordinate ranges defining areas and/or regions of various sizes may be stored in the one or more intermediate levels 502, 504, and so forth, such as 502a . . . 502m and 504a . . . 504n.

For example, in one embodiment, the lowest level 506 may store the geographic mnemonics and their associated data having geographic coordinates of specific locations, e.g. “1 Telegraph Hill Blvd, San Francisco, Calif.” A next immediate intermediate level, e.g., level 504, may store geographic mnemonics and their associated data having geographic coordinates of a wider area, such as a City like San Francisco, Los Angeles, and so forth. Further, another intermediate level (not shown) above intermediate level 504 may store may store geographic mnemonics and their associated data having geographic coordinate ranges defining States, such as California, Oregon, and so forth. Still further, yet another intermediate level, such as intermediate level 502 may store geographic mnemonics and their associated data having geographic coordinate ranges representing Countries, such as United States, Canada, and so forth.

The above example is not intended to be limiting on the present disclosure. The present disclosure may be practiced with any data organization or structure, depending on the application. In the case of hierarchical organization, the hierarchical organization may have any number of levels, with the nodes of the intermediate levels storing geographic coordinate ranges defining any geographic, political, cultural, social, and/or economic organizations.

In applications/embodiments, or in a particular instance in time in the use of an application, one or more operational subsets of the geographic mnemonics and their associated data 138 may be cached by one or more client devices 104 or servers 102 and 106. For example, a portable or handheld client device 104 may be provided with the subset of geographic mnemonics and their associated data of one or more areas, regions, if the application or an instant use of the application is known to be confined in the one or more areas/regions. The example subset is not meant to be limiting, other subset derivations of the larger set of geographic mnemonics and associated data are also possible and anticipated.

For the example applications/embodiments, the subset of geographic mnemonics and their related may be stored in e.g., a content addressable memory (CAM), which is described in further detail in related application, U.S. patent application Ser. No. ______, attorney docket 125621-192392, entitled “Geographic Mnemonics,” contemporaneously filed.

Referring now FIG. 1 again, while for ease of understanding, geographic mnemonics service, and geographic mnemonics based demographics service are described as being operated from separate servers 102 and 162, and separate from servers 106 of other online services. The description is not to be construed to be limiting. In embodiments, geographic mnemonics service and geographic mnemonics based demographics service may be operated from the same server or same cluster of server. Further, in embodiments, geographic mnemonics service and/or geographic mnemonics based demographics service may be provider by the same provider of one or more of the other online services. For example, a provider who provides a multitude of online services, such as search engine service, email service, social network service, and so forth, may elect to also provide the geographic mnemonics service and/or geographic mnemonics based demographics service.

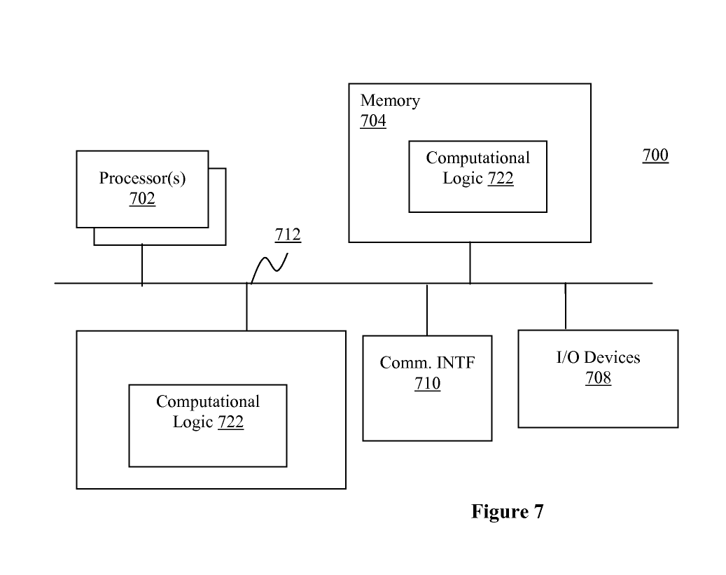

Referring now to FIG. 7, wherein an example computer suitable for use as either client device 104 or server 102/106/162 of FIG. 1, in accordance with various embodiments, is illustrated. As shown, computer 700 may include one or more processors or processor cores 702, and system memory 704. For the purpose of this application, including the claims, the terms “processor” and “processor cores” may be considered synonymous, unless the context clearly requires otherwise. System memory 704 may include volatile and or non-volatile memory, including CAM. Additionally, computer 700 may include mass storage devices 706 (such as diskette, hard drive, compact disc read only memory (CD-ROM) and so forth), input/output devices 708 (such as display, keyboard, cursor control and so forth) and communication interfaces 710 (such as network interface cards, modems and so forth). The elements may be coupled to each other via system bus 712, which may represent one or more buses. In the case of multiple buses, they may be bridged by one or more bus bridges (not shown).

Each of these elements may perform its conventional functions known in the art. In particular, system memory 704 and mass storage devices 706 may be employed to store a working copy and a permanent copy of the programming instructions implementing the various operations earlier described, e.g., the operations associated with registration engine 132, response engine 134, data collection module 182, an/or application services 144 collectively denoted as computational logic 722. Computational logic 722 may be implemented with assembler instructions supported by processor(s) 702 or high-level languages, such as, for example, C, that can be compiled into such instructions.

The permanent copy of the programming instructions may be placed into permanent storage devices 706 in the factory, or in the field, through, for example, a distribution medium (not shown), such as a compact disc (CD), or through communication interface 710 (from a distribution server (not shown)). That is, one or more distribution media having an implementation of computational logic 722 may be employed to distribute computational logic 722 and program various computing devices.

The number, capability and/or capacity of these elements 710-712 may vary, depending on whether computer 700 is used as a client device 104 or server 102/106/162. When use as client device 104, whether client device 104 is a stationary or mobile device, like a smartphone, in-vehicle/portable navigation/infotainment systems, computing tablet, ultrabook or laptop, with general or specific applications. The constitutions of these elements are otherwise known, and accordingly will not be further described.

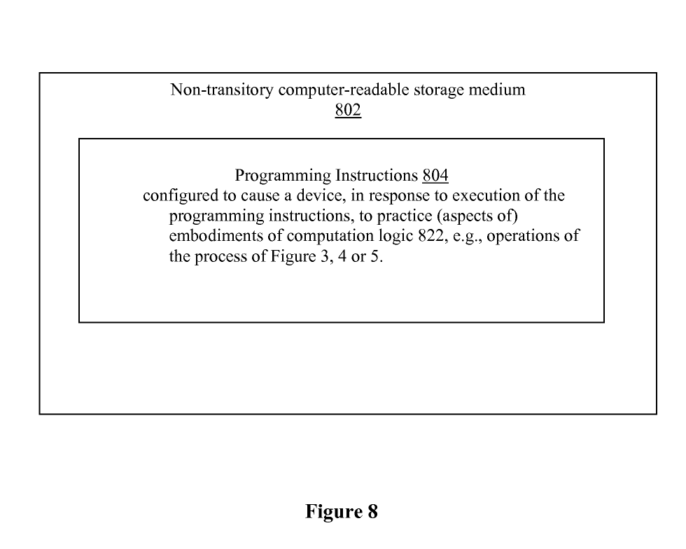

FIG. 8 illustrates an example non-transitory computer-readable storage medium having instructions configured to practice all or selected ones of the operations associated with registration engine 132, response engine 134, data collection module 182, and/or application services 144, earlier described; in accordance with various embodiments. As illustrated, non-transitory computer-readable storage medium 802 may include a number of programming instructions 804. Programming instructions 804 may be configured to enable a device, e.g., computer 400, in response to execution of the programming instructions, to perform various ones of the earlier described operations, e.g., various operations of process 300 of FIG. 3, process 350 of FIG. 4, or process 400 of FIG. 5. In alternate embodiments, programming instructions 804 may be disposed on multiple non-transitory computer-readable storage media 802 instead.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the examples.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus for messaging a client device, comprising:
one or more processors;
one or more communication interfaces coupled with the one or more processors; and
a data collection module configured to be operated by the one or more processors to collect demographics of users interacting with a geographic mnemonics associated with a location or an area that includes the location; and in response to a request from a requestor for the demographics of users interacting with the geographic mnemonics, respond to the requestor with collected demographics of users interacting with the geographic mnemonics, to enable the requestor to select and transmit a message to the client device, based at least in part on the collected demographics of users interacting with the geographic mnemonics.

2. The apparatus of claim 1, wherein the geographic mnemonics comprises a special character followed by a plurality of alphanumeric or special characters.

3. The apparatus of claim 1, wherein the data collection module is configured to collect, from a geographic mnemonics service, demographics of owners who register the geographic mnemonics with the geographic mnemonics service.

4. The apparatus of claim 1, wherein the data collection module is configured to collect, from an Internet portal, or an ecommerce site, demographics of registered user who are also owners of registered geographic mnemonics with the geographic mnemonics service.

5. The apparatus of claim 1, wherein the data collection module is configured to collect, from a geographic mnemonics service, demographics of users who queried a geographic mnemonics service about the geographic mnemonics.

6. The apparatus of claim 1, wherein the data collection module is configured to collect, from a search engine, demographics of users who issued searches to the search engine that triggered the search engine to query a geographic mnemonics service about the geographic mnemonics.

7. The apparatus of claim 1, wherein the data collection module is configured to collect, from a social networking site, demographics of users who associated themselves with the geographic mnemonics on the social networking site.

8. The apparatus of claim 1, wherein the data collection module is configured to collect, from an email service, demographics of users who send or receive emails that include the geographic mnemonics.

9. The apparatus of claim 1, wherein the data collection module is configured to collect, from a messaging service, demographics of users who follow the geographic mnemonics on a messaging service.

10. The apparatus of claim 1, wherein the requestor is a selected one of an Internet portal, an ecommerce site, a search engine, a social networking site, an email service, or a messaging service, and wherein the responded demographics of users interacting with the geographic mnemonics enable the selected one of the Internet portal, the ecommerce site, the search engine, the social networking site, the email service, or the messaging service, to select and transmit a message to a client device, based at least in part on the responded demographics of users interacting with the geographic mnemonic.

11. The apparatus of claim 10, wherein the message comprises a commercial message.

12. At least one computer-readable non-transitory storage medium comprising a plurality of instructions configured to cause a computer system, in response to execution of the instructions by the computer system, to:
respond to a request from a requestor for demographics of users interacting with geographic mnemonics, with collected demographics of users interacting with the geographic mnemonics, to enable the requestor to select and transmit a message to a client device, based at least in part on the collected demographics of users interacting with the geographic mnemonics.

13. The storage medium of claim 12, wherein the geographic mnemonics comprises a special character followed by a plurality of alphanumeric or special characters.

14. The storage medium of claim 12, wherein the computer system is further caused to collect, from a geographic mnemonics service, demographics of owners who register the geographic mnemonics with the geographic mnemonics service.

15. The storage medium of claim 12, wherein the computer system is further caused to collect, from an Internet portal, or an ecommerce site, demographics of registered user who are also owners of registered geographic mnemonics with the geographic mnemonics service.

16. The storage medium of claim 12, wherein the computer system is further caused to collect, from a geographic mnemonics service, demographics of users who queried a geographic mnemonics service about the geographic mnemonics.

17. The storage medium of claim 12, wherein the computer system is further caused to collect, from a search engine, demographics of users who issued searches to the search engine that triggered the search engine to query a geographic mnemonics service about the geographic mnemonics.

18. The storage medium of claim 12, wherein the computer system is further caused to collect, from a social networking site, demographics of users who associated themselves with the geographic mnemonics on the social networking site.

19. The storage medium of claim 12, wherein the computer system is further caused to collect, from an email service, demographics of users who send or receive emails that include the geographic mnemonics.

20. The storage medium of claim 12, wherein the computer system is further caused to collect, from a messaging service, demographics of users who follow the geographic mnemonics on a messaging service.

21. The storage medium of claim 12, wherein the requestor is a selected one of an Internet portal, an ecommerce site, a search engine, a social networking site, an email service, or a messaging service, and wherein the responded demographics of users interacting with the geographic mnemonics enable the selected one of the Internet portal, the ecommerce site, the search engine, the social networking site, the email service, or the messaging service, to select and transmit a message to a client device, based at least in part on the responded demographics of users interacting with the geographic mnemonic.

22. A computer-implemented method for messaging a client device, comprising:
collecting, by a computer system, demographics of users interacting with a geographic mnemonics associated with a location or an area that includes the location; and
in response to a request from a requestor for the demographics of users interacting with the geographic mnemonic, responding, by the computer system, with collected demographics of users interacting with the geographic mnemonic, to enable the requestor to select and transmit a message to a client device, based at least in part on the collected demographics of users interacting with the geographic mnemonics.

23. The method of claim 22, wherein the geographic mnemonics comprises a special character followed by a plurality of alphanumeric or special characters.

24. An apparatus for messaging a client device, comprising:
one or more processors;
one or more communication interfaces coupled with the one or more processors; and
a search engine configured to be operated by the one or more processors to provide search services to a plurality of client devices, wherein the search services include searches for geographic mnemonics, information associated with geographic mnemonics, or geographic mnemonics at a location or within an area; and wherein the search engine is further configured to collaborate with a geographic mnemonics based demographics service to enable the search engine to select and transmit a commercial/advertisement message to a client device, based at least in part on demographics data of users who interact with a geographic mnemonics, or demographics data of users who interact with other geographic mnemonics associated with the geographic mnemonics.

25. The apparatus of claim 24, wherein the search engine is configured to provide demographics data of users who issued searches to the search engine that triggered the search engine to query a geographic mnemonics service about the geographic mnemonics, to the geographic mnemonics based demographic service.

26. The apparatus of claim 24, wherein the search engine is configured to request, from the geographic mnemonics based demographics service, demographics data of users who interact with a geographic mnemonics or demographics data of users who interact with other geographic mnemonics related to the geographic mnemonics.

27. The apparatus of claim 26, wherein the requested demographics data of users include demographics of users who associated themselves with the geographic mnemonics on the social networking site, demographics of users who send or receive emails that include the geographic mnemonics, or demographics of users who follow the geographic mnemonics on a messaging service, collected by the geographic mnemonics based demographics service.

28. The apparatus of claim 24, further comprising the geographic mnemonics based demographics service.

29. An apparatus for messaging a client device, comprising:
one or more processors;
one or more communication interfaces coupled with the one or more processors; and
a social networking service configured to be operated by the one or more processors to provide social networking to a plurality of client devices, wherein the social networking service includes supports for the geographic mnemonics as users, and supports for other users to be associated with or interact with the geographic mnemonics; and wherein the social networking service is further configured to collaborate with a geographic mnemonics based demographics service to enable the social networking service to select and transmit a commercial/advertisement message to a client device, based at least in part on demographics data of users who interact with a geographic mnemonics, or demographics data of users who interact with other geographic mnemonics related to the geographic mnemonics.

30. The apparatus of claim 29, wherein the social networking service is configured to provide demographics data of users who associated themselves with the geographic mnemonics on the social networking site to the geographic mnemonics based demographic service.

31. The apparatus of claim 29, wherein the social networking service is configured to request, from the geographic mnemonics based demographics service, demographics data of users who interact with a geographic mnemonics, or demographics data of users who interact with other geographic mnemonics related to the geographic mnemonics.

32. The apparatus of claim 31, wherein the requested demographics data of users include demographics data of users who issued searches to a search engine that triggered the search engine to query a geographic mnemonics service about the geographic mnemonics, demographics of users who associated themselves with the geographic mnemonics on the social networking site, demographics of users who send or receive emails that include the geographic mnemonics, or demographics of users who follow the geographic mnemonics on a messaging service, collected by the geographic mnemonics based demographics service.

33. The apparatus of claim 29, further comprising the geographic mnemonics based demographics service.

34. An apparatus for messaging a client device, comprising:
one or more processors;
one or more communication interfaces coupled with the one or more processors; and
a messaging service configured to be operated by the one or more processors to facilitate messaging by a plurality of client devices, wherein the messaging service includes support for geographic mnemonics; and wherein the social networking service is further configured to collaborate with a geographic mnemonics based demographics service to enable the social networking service to select and transmit a commercial/advertisement message to a client device, based at least in part on demographics data of users who interact with a geographic mnemonics, or demographics data of users who interact with other geographic mnemonics related to the geographic mnemonics.

35. The apparatus of claim 34, wherein the messaging service is configured to provide demographics data of users who follow the geographic mnemonics on a messaging service to the geographic mnemonics based demographic service.

36. The apparatus of claim 34, wherein the messaging service is configured to request, from the geographic mnemonics based demographics service, demographics data of users who interact with a geographic mnemonics, or demographics data of users who interact with other geographic mnemonics related to the geographic mnemonics.

37. The apparatus of claim 34, wherein the requested demographics data of users include demographics data of users who issued searches to a search engine that triggered the search engine to query a geographic mnemonics service about the geographic mnemonics, demographics of users who associated themselves with the geographic mnemonics on the social networking site, or demographics of users who send or receive emails that include the geographic mnemonics, collected by the geographic mnemonics based demographics service.

38. The apparatus of claim 34, further comprising the geographic mnemonics based demographics service.

39. An apparatus for messaging a client device, comprising:
one or more processors;
one or more communication interfaces coupled with the one or more processors; and
an Internet portal service, an ecommerce service or an email service configured to be operated by the one or more processors to respectively offer Internet portal service, or ecommerce service or email service to a plurality of client devices, wherein the Internet portal service, the ecommerce service or the email service is further configured to collaborate with a geographic mnemonics based demographics service to enable the Internet portal service, an ecommerce service or an email service to select and transmit a message to a client device, based at least in part on demographics data of users who interact with a geographic mnemonics, or demographics data of users who interact with other geographic mnemonics related to the geographic mnemonics.

40. The apparatus of claim 39, wherein the Internet portal service, the ecommerce service or the email service is configured to provide demographics data of users to the geographic mnemonics based demographic service.

41. The apparatus of claim 39, wherein the Internet portal service, the ecommerce service or the email service is configured to request, from the geographic mnemonics based demographics service, demographics data of users who interact with a geographic mnemonics, or demographics data of users who interact with other geographic mnemonics related to the geographic mnemonics.

42. The apparatus of claim 38, wherein the requested demographics data of users include demographics data of users who issued searches to a search engine that triggered the search engine to query a geographic mnemonics service about the geographic mnemonics, demographics of users who associated themselves with the geographic mnemonics on the social networking site, demographics of users who send or receive emails that include the geographic mnemonics, or demographics of users who follow the geographic mnemonics on a messaging service, collected by the geographic mnemonics based demographics service.

43. The apparatus of claim 39, further comprising the geographic mnemonics based demographics service.
